(19) United States
(12) Patent Application Publication
(10) Pub. No.: US 2024/0312065 A1
(43) Pub. Date: Sep. 19, 2024

(54) METHOD AND APPARATUS FOR DIVIDING PARTIAL SYMMETRY MESH

(71) Applicant: TENCENT AMERICA LLC, Palo Alto, CA (US)

(72) Inventors: Fang-Yi CHAO, Palo Alto, CA (US); Thuong NGUYEN CANH, Palo Alto, CA (US); Xiaozhong XU, Palo Alto, CA (US); Shan Liu, Palo Alto, CA (US)

(73) Assignee: TENCENT AMERICA LLC, Palo Alto, CA (US)

(21) Appl. No.: 18/602,833

(22) Filed: Mar. 12, 2024

Related U.S. Application Data
(60) Provisional application No. 63/489,851, filed on Mar. 13, 2023.

(51) Int. Cl. G06T 9/00

(52) U.S. Cl. CPC G06T 9/001

(57) ABSTRACT

According to one or more embodiments, a method of encoding a mesh includes: determining a global symmetry plane of the mesh that divides the mesh into a first side and a second side; based on the determination that the mesh is partially symmetric: determining each vertex from the plurality of vertices having a symmetry error larger than a first error threshold; performing a clustering process on the plurality of vertices based on the determined symmetry error for each vertex such that each vertex having a symmetry error larger than the first symmetry error threshold is clustered together in one or more clusters; dividing the mesh into a plurality of sub-meshes based on the clustering process; determining whether each sub-mesh is one of fully symmetric, partially symmetric, and asymmetric; and performing symmetry coding on each sub-mesh from the plurality of sub-meshes that is determined to be fully symmetric.

### CROSS-REFERENCE TO RELATED APPLICATION

This application claims priority from U.S. Provisional Application No. 63/489,851 filed on Mar. 13, 2023, the disclosure of which is incorporated herein by reference in its entirety.

### FIELD

This disclosure is directed to a set of advanced video coding technologies. More specifically, the present disclosure is directed to a method and apparatus dividing partial symmetry meshes.

### BACKGROUND

VMesh is an ongoing MPEG standard to compress dynamic meshes. The current VMesh reference software compresses meshes based on decimated base meshes, displacements vectors and motion fields. The displacements are calculated by searching the closest point on the input mesh with respect to each vertex of the subdivided based mesh. To encode the displacement, displacement vectors are transformed into wavelet coefficients by a linear lifting scheme, and then the coefficients are quantized and coded by a video codec or arithmetic codec. This process also refines the base mesh to minimize the displacement. Texture transfer may be performed to match the texture with reparameterized geometry and UV as well as optimized texture for image compression.

Reflection symmetry is a popular characteristic of mesh coding, especially computer generated meshes. Symmetry was utilized to compress symmetry mesh. Vertices are divided into a left and right part of a symmetry plane. The left part is encoded by mesh coding while the right part is encoded by a symmetry prediction and displacement coding.

However, many meshes are not perfectly symmetric with a single symmetry plane. One mesh may be symmetric of a plane on a portion and symmetric of another plane on another portion. One mesh may also have symmetric portions and asymmetric portions.

### SUMMARY

According to one or more embodiments, a method of encoding a mesh, the method comprises: determining a global symmetry plane of the mesh that divides the mesh into a first side and a second side; determining, using the global symmetry plane, whether the mesh is one of fully symmetric, partially symmetric, and asymmetric based on a statistical calculation performed on a plurality of vertices in the mesh; based on the determination that the mesh is partially symmetric: determining each vertex from the plurality of vertices having a symmetry error larger than a first error threshold; performing a clustering process on the plurality of vertices based on the determined symmetry error for each vertex such that each vertex having a symmetry error larger than the first symmetry error threshold is clustered together in one or more clusters; dividing the mesh into a plurality of sub-meshes based on the clustering process; determining whether each sub-mesh is one of fully symmetric, partially symmetric, and asymmetric; and performing symmetry coding on each sub-mesh from the plurality of sub-meshes that is determined to be fully symmetric.

According to one or more embodiments, a method of encoding a mesh, comprises generating a bitstream comprising the mesh; wherein the mesh is divided by a global symmetry plane into a first side and a second side; wherein the mesh is determined to be, using the global symmetry plane, whether one of fully symmetric, partially symmetric, and asymmetric based on a statistical calculation performed on a plurality of vertices in the mesh; wherein based on the determination that the mesh is partially symmetric: each vertex from the plurality of vertices having a symmetry error larger than a first error threshold is determined; a clustering process is performed on the plurality of vertices based on the determined symmetry error for each vertex such that each vertex having a symmetry error larger than the first symmetry error threshold is clustered together in one or more clusters; the mesh is divided into a plurality of sub-meshes based on the clustering process; each sub-mesh is determined to be one of fully symmetric, partially symmetric, and asymmetric; and symmetry coding is performed on each sub-mesh from the plurality of sub-mesh that is determined to be fully symmetric.

According to one or more embodiments, a method of decoding a mesh, the mesh comprising receiving a bitstream comprising the mesh; wherein the mesh is divided by a global symmetry plane into a first side and a second side; wherein the mesh is determined to be, using the global symmetry plane, whether one of fully symmetric, partially symmetric, and asymmetric based on a statistical calculation performed on a plurality of vertices in the mesh; wherein based on the determination that the mesh is partially symmetric: each vertex from the plurality of vertices having a symmetry error larger than a first error threshold is determined; a clustering process is performed on the plurality of vertices based on the determined symmetry error for each vertex such that each vertex having a symmetry error larger than the first symmetry error threshold is clustered together in one or more clusters; the mesh is divided into a plurality of sub-meshes based on the clustering process; each sub-mesh is determined to be one of fully symmetric, partially symmetric, and asymmetric; and symmetry coding is performed on each sub-mesh from the plurality of sub-mesh that is determined to be fully symmetric.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a block diagram of a communication system, in accordance with embodiments of the present disclosure.

FIG. 2 is a schematic illustration of a block diagram of a streaming system, in accordance with embodiments of the present disclosure.

FIG. 3 is a schematic illustration of an example mesh encoder, in accordance with embodiments of the present disclosure.

FIG. 4(A) illustrates a mesh with a global symmetry plane, in accordance with embodiments of the present disclosure.

FIG. 4(B) illustrates vertices having a symmetry error larger than an error threshold, in accordance with embodiments of the present disclosure.

FIG. 4(C) illustrates clusters of the vertices, in accordance with embodiments of the present disclosure.

FIG. 4(D) illustrates cutting planes that divide clusters, in accordance with embodiments of the present disclosure.

FIG. 4(E) illustrates an estimated symmetry planes of each slice, in accordance with embodiments of the present disclosure.

FIG. 5(A) illustrates a mesh with a global symmetry plane, in accordance with embodiments of the present disclosure.

FIG. 5(B) illustrates a mesh cut into two slices, in accordance with embodiments of the present disclosure.

FIG. 5(C) illustrates symmetry planes of each slice, in accordance with embodiments of the present disclosure.

FIG. 6 is a flowchart of an example process for performing mesh encoding, in accordance with embodiments of the present disclosure.

FIG. 7 is a diagram of a computer system suitable for implementing the embodiments of the present disclosure, in accordance with embodiment of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment).). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

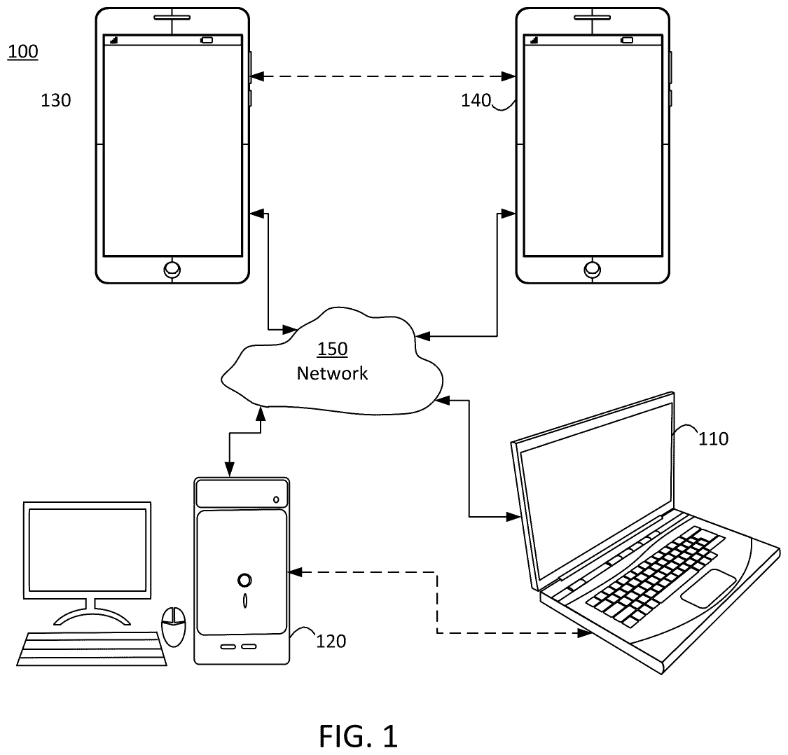

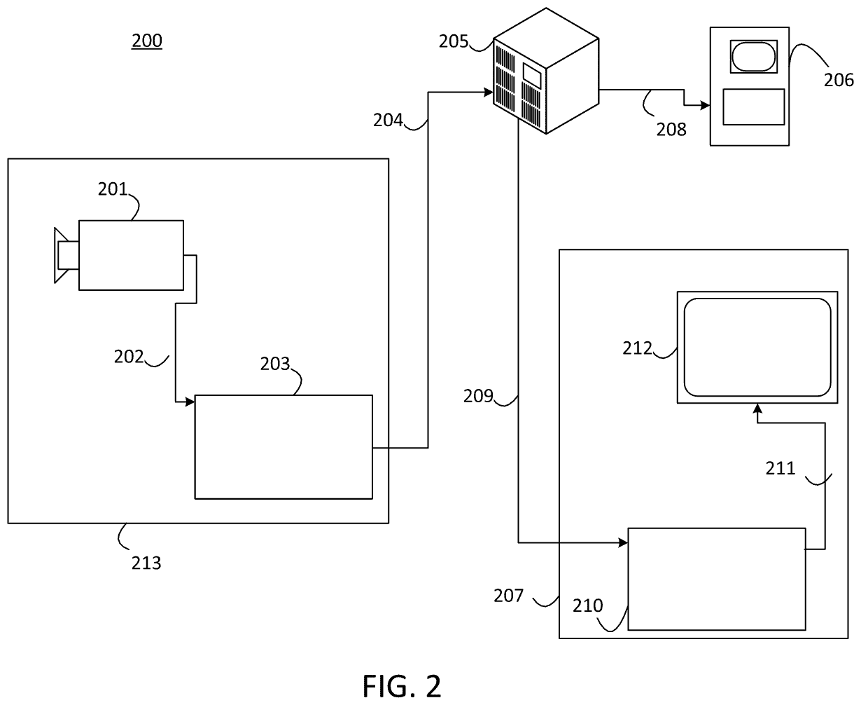

With reference to FIGS. 1-2, one or more embodiments of the present disclosure for implementing encoding and decoding structures of the present disclosure are described.

FIG. 1 illustrates a simplified block diagram of a communication system 100 according to an embodiment of the present disclosure. The system 100 may include at least two terminals 110, 120 interconnected via a network 150. For unidirectional transmission of data, a first terminal 110 may code video data, which may include mesh data, at a local location for transmission to the other terminal 120 via the network 150. The second terminal 120 may receive the coded video data of the other terminal from the network 150, decode the coded data and display the recovered video data. Unidirectional data transmission may be common in media serving applications and the like.

FIG. 1 illustrates a second pair of terminals 130, 140 provided to support bidirectional transmission of coded video that may occur, for example, during videoconferencing. For bidirectional transmission of data, each terminal 130, 140 may code video data captured at a local location for transmission to the other terminal via the network 150. Each terminal 130, 140 also may receive the coded video data transmitted by the other terminal, may decode the coded data and may display the recovered video data at a local display device.

In FIG. 1, the terminals 110-140 may be, for example, servers, personal computers, and smart phones, and/or any other type of terminals. For example, the terminals (110-140) may be laptop computers, tablet computers, media players and/or dedicated video conferencing equipment. The network 150 represents any number of networks that convey coded video data among the terminals 110-140 including, for example, wireline and/or wireless communication networks. The communication network 150 may exchange data in circuit-switched and/or packet-switched channels. Representative networks include telecommunications networks, local area networks, wide area networks, and/or the Internet. For the purposes of the present discussion, the architecture and topology of the network 150 may be immaterial to the operation of the present disclosure unless explained herein below.

FIG. 2 illustrates, as an example of an application for the disclosed subject matter, a placement of a video encoder and decoder in a streaming environment. The disclosed subject matter may be used with other video enabled applications, including, for example, video conferencing, digital TV, storing of compressed video on digital media including CD, DVD, memory stick and the like, and so on.

As illustrated in FIG. 2, a streaming system 200 may include a capture subsystem 213 that includes a video source 201 and an encoder 203. The streaming system 200 may further include at least one streaming server 205 and/or at least one streaming client 206.

The video source 201 may create, for example, a stream 202 that includes a 3D mesh and metadata associated with the 3D mesh. The video source 201 may include, for example, 3D sensors (e.g. depth sensors) or 3D imaging technology (e.g. digital camera(s)), and a computing device that is configured to generate the 3D mesh using the data received from the 3D sensors or the 3D imaging technology. The sample stream 202, which may have a high data volume when compared to encoded video bitstreams, may be processed by the encoder 203 coupled to the video source 201. The encoder 203 may include hardware, software, or a combination thereof to enable or implement aspects of the disclosed subject matter as described in more detail below. The encoder 203 may also generate an encoded video bitstream 204. The encoded video bitstream 204, which may have a lower data volume when compared to the uncompressed stream 202, may be stored on a streaming server 205 for future use. One or more streaming clients 206 and 207 may access the streaming server 205 to retrieve video bit streams 208 and 209, respectively that may be copies of the encoded video bitstream 204.

The streaming clients 207 may include a video decoder 210 and a display 212. The video decoder 210 may, for example, decode video bitstream 209, which is an incoming copy of the encoded video bitstream 204, and create an outgoing video sample stream 211 that may be rendered on the display 212 or another rendering device (not depicted). In some streaming systems, the video bitstreams 204, 208, and 209 may be encoded according to certain video coding/compression standards.

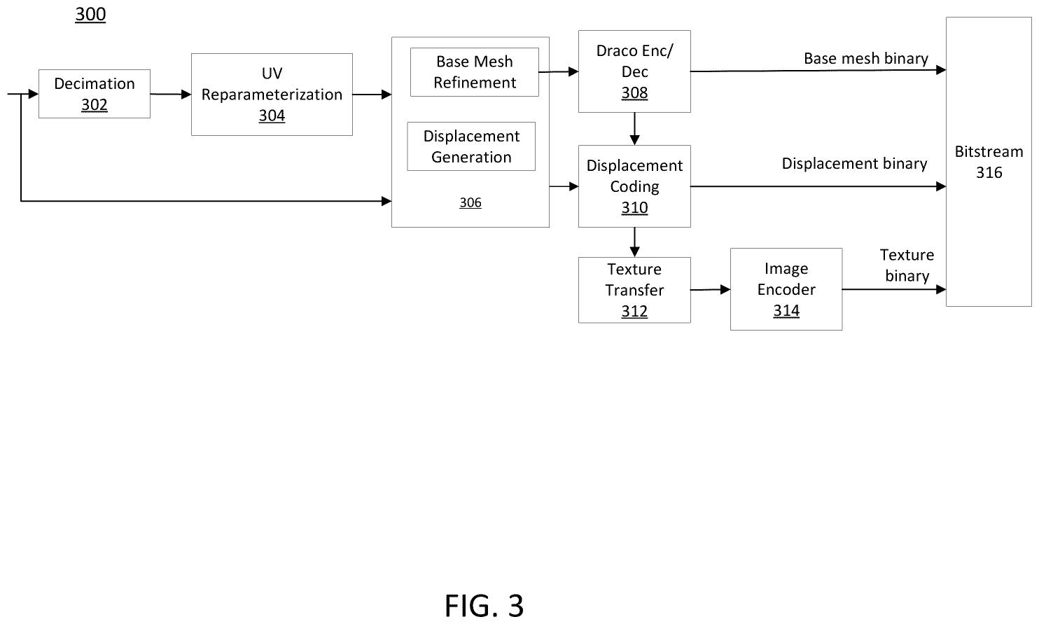

FIG. 3 illustrates an example mesh encoder 300. The encoder 300 may perform the V-DMC process for performing decimation and reparameterization before encoding a bitstream. As illustrated in FIG. 3, an input mesh may be subject to decimation 302 and UV reparameterization 304. Subsequently geometry reparameterization 306 is performed that includes base mesh refinement and displacement generation. The output of the base mesh refinement is provided to a Draco encoder 308 to generate a base mesh binary. The output of the displacement generation is provided to displacement coding 310 to generate displacement binary. The output of displacement coding 310 is provided to texture transfer 312 and image encoder 314 to generate texture binary. The base mesh binary, texture binary, and displacement binary may be included in bitstream 316. In one or more examples, texture coordinates or UV coordinates (often shortened to UVs) map the vertices to locations on the textures through a process called “UV Mapping”. The UVs define a 2D position in texture space for each vertex in the mesh.

A mesh is composed of several polygons that describe the surface of a volumetric object. Each polygon is defined by its vertices in 3D space and the information of how the vertices are connected, referred to as connectivity information. Optionally, vertex attributes, such as colors, normals, etc., could be associated with the mesh vertices. Attributes could also be associated with the surface of the mesh by exploiting mapping information that parameterizes the mesh with 2D attribute maps. Such mapping is usually described by a set of parametric coordinates, referred to as UV coordinates or texture coordinates, associated with the mesh vertices. 2D attribute maps are used to store high resolution attribute information such as texture, normals, displacements etc. Such information could be used for various purposes such as texture mapping and shading.

Mesh geometry information consists of vertex connectivity information, 3D coordinates, and 2D texture coordinates, etc. The compression of vertex 3D coordinates, which is also called vertex position, is very important, as in most cases, it takes up significant portion of the entire geometry related data.

Embodiments of the present disclosure directed to deriving multiple mirror symmetry planes. The embodiments of the present disclosure are further directed to removing asymmetric portions in a mesh object.

The proposed methods may be used separately or combined in any order and may be used for arbitrary polygon meshes. According to the embodiments of the present disclosure, a mesh is assumed to be fully symmetric, partially symmetric, or asymmetric in geometry.

According to one or more embodiments, a method distinguishes full symmetry, partial symmetry, or asymmetry meshes. The method derives multiple symmetry planes in a partial symmetry mesh. An embodiment of the overall process is described below based on a mesh [symbol] and vertices V in mesh [symbol] .

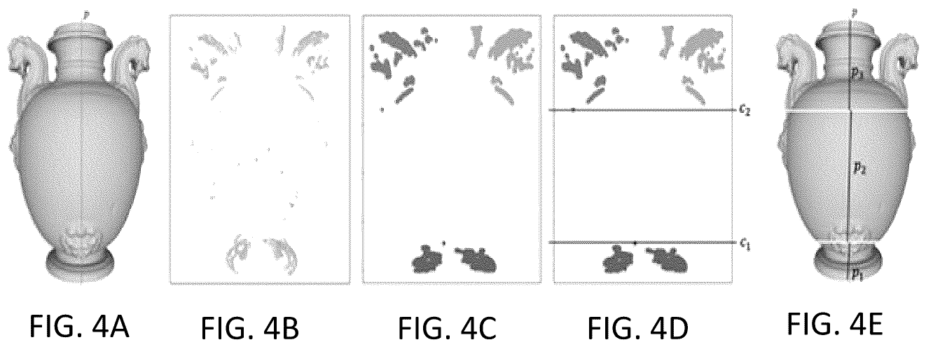

Operation 1. Estimate a global mirror symmetry plane p of mesh [symbol] as illustrated in in FIG. 4(a).

Operation 2. Compute the symmetry error err_{sym} of the vertices reflected from the mirror symmetry plane p and normalized the symmetry error err_{sym} with the scale of mesh [symbol] . The normalization of symmetry error may be defined as:

$${err}_{sym} = \frac{{err}_{sym}}{MaxBoundingBox ( ℳ )} . \qquad Eq . ( 1 )$$

$$MaxBoundingBox ( ℳ ) = Max ( {V}_{x}^{max} - {V}_{x}^{min} , {V}_{y}^{max} - {V}_{y}^{min} , {V}_{z}^{max} - {V}_{z}^{min} ) , \qquad Eq . ( 2 )$$

where (Vₓ, V_{y}, V_{z}) are the vertices of mesh [symbol] in (x, y, z) dimensions.

Operation 3. Compute the symmetry ratio symᵣₐₜᵢₒ to show how many percentages of the vertices have the err_{sym} smaller than a threshold errₜₕᵣₑₛ. The symᵣₐₜᵢₒ may be determined as follows:

$${sym}_{ratio} = \frac{the number of vertices that have {err}_{sym} < {err}_{thres}}{total number of vertices} . \qquad Eq . ( 3 )$$

If the symᵣₐₜᵢₒ is greater than or equal to symₜₕᵣₑₛ₁,the mesh may be marked as full symmetry, and the operation stops. In one or more embodiments, symₜₕᵣₑₛ₁=1 is set. If the symᵣₐₜᵢₒ is smaller than a symmetry threshold symₜₕᵣₑₛ₂, the mesh may be marked as asymmetric, and the operation stops. If the symᵣₐₜᵢₒ larger or equal to symₜₕᵣₑₛ₂ but smaller than symₜₕᵣₑₛ₁, the mesh may be marked as partially symmetric. The symmetry threshold symₜₕᵣₑₛ₁ may be larger than symₜₕᵣₑₛ₂.

Operation 4. For the mesh that is marked partial symmetry, the vertices that have symmetry errors err_{sym} larger than the threshold errₜₕᵣₑₛ₂, are determined as shown in FIG. 4(B). In one or more examples, the symmetry error err_{sym} may be determined by reflecting a vertex from the symmetry plane and determining a distance to the nearest vertex. For example, for a vertex on the left side of a mesh, the symmetry error for this vertex may be determined by reflecting the vertex across the symmetry plane to find the symmetric vertex on the right side of the mesh, and determine a nearest vertex on the right side of the mesh to the symmetric vertex. If this distance is zero (e.g., nearest vertex on right side matches symmetric vertex), the err_{sym} is zero.

Operation 5. A clustering algorithm may be used to classify the adjacent vertices into clusters, as illustrated in FIG. 4(c). In one or more examples, DBSCAN may be used as the clustering algorithm. As understood by one of ordinary skill in the art, any suitable clustering algorithm may be used.

Operation 6. The boundary of each cluster along the orientation of the global symmetry plane p is determined. A cutting plane cᵢ may be generated at each cluster's boundary and perpendicular to the global symmetry plane p, as illustrated in FIG. 4(d). In one or more examples, if two cutting planes are too close to each other (e.g., a distance between two cutting planes is less than a predetermined distance), the two cutting planes may be merged as one cutting plane.

Operation 7. The mesh [symbol] inis separated into multiple slices (e.g. sub-meshes) by using the cutting plane cᵢ. The symmetry plane pᵢ (e.g., local symmetry plane) may be estimated for each slice by utilizing the global symmetry plane p as the initial input plane, as illustrated in FIG. 4(E).

Operation 8. The symᵣₐₜᵢₒ of each divided slice is computed as shown in equation 3. Based on the computed , each slice (e.g., sub-mesh) is determined to be one of fully symmetric, partially symmetric, or asymmetric in accordance with Operation 3. In Operation 8, the symmetry thresholds symₜₕᵣₑₛ₁ and symₜₕᵣₑₛ₂ used in Operation 3 may be replaced with symmetry thresholds symₜₕᵣₑₛ₃ and symₜₕᵣₑₛ₄, respectively. The symmetry threshold symₜₕᵣₑₛ₃ may be larger than symₜₕᵣₑₛ₄. In one or more examples, for each divided slice, Operation 1 to Operation 7 may be repeated to further divide the symmetry part in each slice.

According to one or more embodiments, after dividing a mesh into symmetry and asymmetry submeshes, symmetry coding, may be performed for the symmetry submeshes. For example, the slices (e.g., sub-meshes) that are determined to be fully symmetric may be encoded in accordance with symmetry encoding. In one or more or more examples, the slices that are determined to be fully symmetric or partially symmetric may be encoded in accordance with symmetry encoding. In the bitstream containing the encoded mesh, each slice may be associated with a flag indicating whether the slice is encoded in accordance with symmetry encoding. Furthermore, each mesh included in the bitstream may be associated with a flag indicating whether the mesh is divided into smaller sub-meshes.

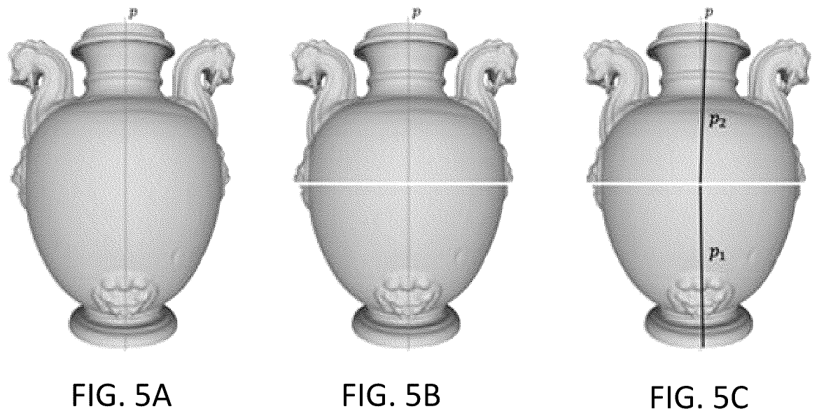

According to one or more embodiments, the operation to cut the mesh [symbol] into the minimum number of slices that results in the smallest average symmetry error. The Operations 1 to 3 may be first applied to find the global symmetry plane and determine if mesh [symbol] is partially symmetric. If mesh [symbol] is partially symmetric, the Operations 9-11 may be performed. The operations 9-11 may be performed based on the mesh illustrated in FIG. 5(a).

Operation 9. The slice number n=1 is set, and the symmetry error err_{sym}¹, which is computed with the global symmetry plane is determined.

Operation 10. Start from n=2, cut the mesh into n slices equally along the orientation of global symmetry plane. Estimate the symmetry plane of each slice, compute the symmetry error of each slice, compute the average symmetry error of all the slices, denoted as err_{sym}¹, as shown in FIGS. 5(b) and 5(c).

Operation 11. If err_{sym}ⁿ<err_{sym}ⁿ⁻¹, repeat Step 5. to cut the mesh into n=n+1 slices. If err_{sym}ⁿ≥err_{sym}ⁿ⁻¹, stop and et the cutting slice number n=n−1.

In one or more examples, after dividing a mesh into n slices (e.g., sub-meshes), symmetry coding may be used for each slice with its symmetry plane.

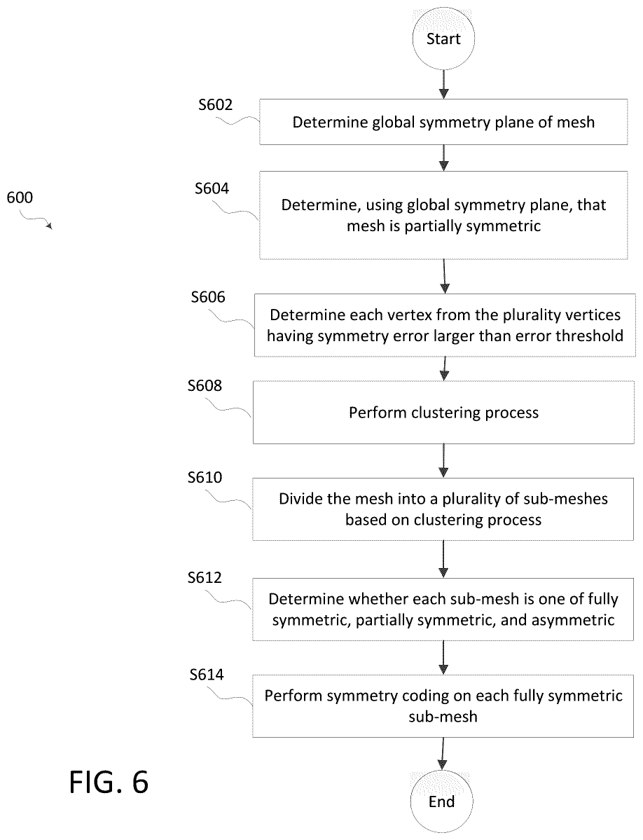

FIG. 6 illustrates a flowchart of a process 600 performed by an encoder. The process 600 may be performed by encoder 203.

The process may start at operation S602 where a global symmetry plane of a mesh is determined. For example, the global symmetry plane p may be determined for the mesh as illustrated in FIG. 4(A). The global symmetry plane p may divide a mesh into a left side (e.g., first side) and a right side (e.g., second side).

The process proceeds to operation S604 where it is determined that a mesh is partially symmetric using the global symmetry plane. For example, determining that a mesh is partially symmetric may be performed in accordance with Operations 1 to 3.

The process proceeds to operation S606 where each vertex in the mesh having a symmetry error larger than an error threshold is determined.

The process proceeds to operation S608 where a clustering process is performed. For example, the clustering process may be performed in accordance with Operation 5.

The process proceeds to operation S610 where the mesh is divided based on the clustering process. For example, the mesh may be divided as illustrated in FIG. 4(D).

The process proceeds to operation S612 where a determination is made whether each sub-mesh is fully symmetric, partially symmetric, or asymmetric. Operations 1 to 3 may be repeated for each sub-mesh.

The process proceeds to operation S614 where a symmetry coding is performed on each sub-mesh that is determined to be fully symmetric.

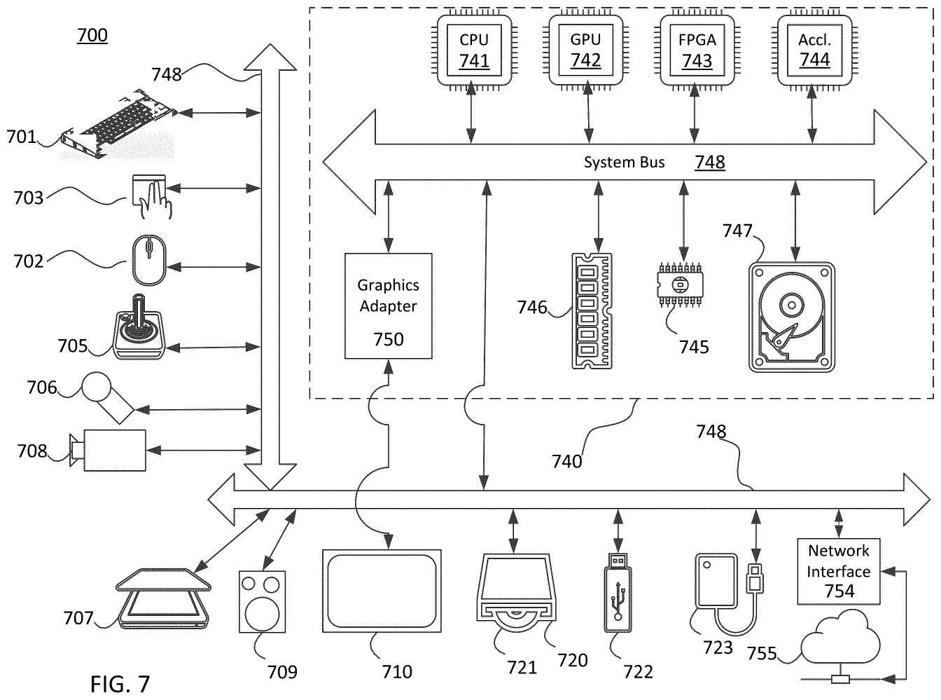

The techniques, described above, may be implemented as computer software using computer-readable instructions and physically stored in one or more computer-readable media. For example, FIG. 7 shows a computer system 700 suitable for implementing certain embodiments of the disclosure.

The computer software may be coded using any suitable machine code or computer language, that may be subject to assembly, compilation, linking, or like mechanisms to create code including instructions that may be executed directly, or through interpretation, micro-code execution, and the like, by computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 7 for computer system 700 are examples and are not intended to suggest any limitation as to the scope of use or functionality of the computer software implementing embodiments of the present disclosure. Neither should the configuration of components be interpreted as having any dependency or requirement relating to any one or combination of components illustrated in the non-limiting embodiment of a computer system 700.

Computer system 700 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 701, mouse 702, trackpad 703, touch screen 710, data-glove, joystick 705, microphone 706, scanner 707, camera 708.

Computer system 700 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 710, data glove, or joystick 705, but there may also be tactile feedback devices that do not serve as input devices). For example, such devices may be audio output devices (such as: speakers 709, headphones (not depicted)), visual output devices (such as screens 710 to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system 700 may also include human accessible storage devices and their associated media such as optical media including CD/DVD ROM/RW 720 with CD/DVD or the like media 721, thumb-drive 722, removable hard drive or solid state drive 723, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 700 may also include interface to one or more communication networks. Networks may be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses 749 (such as, for example USB ports of the computer system 700; others are commonly integrated into the core of the computer system 700 by attachment to a system bus as described below (for example Ethernet interface into a PC computer system or cellular network interface into a smartphone computer system). Using any of these networks, computer system 700 may communicate with other entities. Such communication may be uni-directional, receive only (for example, broadcast TV), uni-directional send-only (for example CANbus to certain CANbus devices), or bi-directional, for example to other computer systems using local or wide area digital networks. Such communication may include communication to a cloud computing environment 755. Certain protocols and protocol stacks may be used on each of those networks and network interfaces as described above.

Aforementioned human interface devices, human-accessible storage devices, and network interfaces 754 may be attached to a core 740 of the computer system 700.

The core 740 may include one or more Central Processing Units (CPU) 741, Graphics Processing Units (GPU) 742, specialized programmable processing units in the form of Field Programmable Gate Areas (FPGA) 743, hardware accelerators for certain tasks 744, and so forth. These devices, along with Read-only memory (ROM) 745, Random-access memory 746, internal mass storage such as internal non-user accessible hard drives, SSDs, and the like 747, may be connected through a system bus 748. In some computer systems, the system bus 748 may be accessible in the form of one or more physical plugs to enable extensions by additional CPUs, GPU, and the like. The peripheral devices may be attached either directly to the core's system bus 748, or through a peripheral bus 749. Architectures for a peripheral bus include PCI, USB, and the like. A graphics adapter 750 may be included in the core 740.

CPUs 741, GPUs 742, FPGAs 743, and accelerators 744 may execute certain instructions that, in combination, may make up the aforementioned computer code. That computer code may be stored in ROM 745 or RAM 746. Transitional data may be also be stored in RAM 746, whereas permanent data may be stored for example, in the internal mass storage 747. Fast storage and retrieve to any of the memory devices may be enabled through the use of cache memory, that may be closely associated with one or more CPU 741, GPU 742, mass storage 747, ROM 745, RAM 746, and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture 700, and specifically the core 740 may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core 740 that are of non-transitory nature, such as core-internal mass storage 747 or ROM 745. The software implementing various embodiments of the present disclosure may be stored in such devices and executed by core 740. A computer-readable medium may include one or more memory devices or chips, according to particular needs. The software may cause the core 740 and specifically the processors therein (including CPU, GPU, FPGA, and the like) to execute particular processes or particular parts of particular processes described herein, including defining data structures stored in RAM 746 and modifying such data structures according to the processes defined by the software. In addition or as an alternative, the computer system may provide functionality as a result of logic hardwired or otherwise embodied in a circuit (for example: accelerator 744), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of encoding a mesh, the method comprising:
determining a global symmetry plane of the mesh that divides the mesh into a first side and a second side;
determining, using the global symmetry plane, whether the mesh is one of fully symmetric, partially symmetric, and asymmetric based on a statistical calculation performed on a plurality of vertices in the mesh;
based on the determination that the mesh is partially symmetric:
determining each vertex from the plurality of vertices having a symmetry error larger than a first error threshold;
performing a clustering process on the plurality of vertices based on the determined symmetry error for each vertex such that each vertex having a symmetry error larger than the first symmetry error threshold is clustered together in one or more clusters;
dividing the mesh into a plurality of sub-meshes based on the clustering process;
determining whether each sub-mesh is one of fully symmetric, partially symmetric, and asymmetric; and
performing symmetry coding on each sub-mesh from the plurality of sub-meshes that is determined to be fully symmetric.

2. The method according to claim 1, wherein the determining, using the global symmetry plane, whether the mesh is one of fully symmetric, partially symmetric, and asymmetric comprises:
determining a symmetry error for each vertex in the mesh;
determining a number of vertices having the symmetry error less than a second error threshold;
determining a symmetry ratio of the mesh by dividing the number of vertices having the symmetry error less than the second error threshold by a total number of vertices in the mesh; and
comparing the symmetry ratio to a first symmetry threshold and a second symmetry threshold that is less than the first symmetry threshold.

3. The method according to claim 2, wherein the comparing the symmetry ratio to the first symmetry threshold and the second symmetry threshold comprises determining the mesh to be partially symmetric based on determining the symmetry ratio is less than the first symmetry threshold and greater than or equal to the second symmetry threshold.

4. The method according to claim 3, wherein the comparing the symmetry ratio to the first symmetry threshold and the second symmetry threshold comprises determining the mesh to be fully symmetric based on determining the symmetry ratio is greater than or equal to the first symmetry threshold.

5. The method according to claim 4, wherein the comparing the symmetry ratio to the first symmetry threshold and the second symmetry threshold comprises determining the mesh to be asymmetric based on determining the symmetry ratio is less than the second symmetry threshold.

6. The method according to claim 2, wherein the determining the symmetry error comprises:
determining, for a vertex on one side of the mesh, a distance between a symmetric reflection of the vertex on another side of the mesh and a nearest vertex on the another side of the mesh.

7. The method according to claim 2, wherein the symmetry ratio is normalized using a bounding box that circumscribes the mesh.

8. The method according to claim 1, wherein the dividing the mesh into a plurality of sub-meshes based on the clustering process comprises:
determining a boundary for each cluster;
generating a cutting plane for each determined boundary such that the each cutting plane separates two adjacent clusters in a direction perpendicular to the global symmetry plane.

9. The method of claim 8, wherein a first cluster that is separated from a second cluster by a distance that is less than or equal to a distance threshold is combined into to a single cluster.

10. The method of claim 1, wherein determining whether each sub-mesh is one of fully symmetric, partially symmetric, and asymmetric comprises performing for each sub-mesh:
determining a local symmetry plane;
determining, using the local symmetry plane, a symmetry error for each vertex in the sub-mesh;
determining a number of vertices having the symmetry error less than a third error threshold;
determining a sub-mesh symmetry ratio of the mesh by dividing the number of vertices having the symmetry error less than the second error threshold by a total number of vertices in the mesh; and
comparing the sub-mesh symmetry ratio to a third symmetry threshold and a fourth symmetry threshold that is less than the third symmetry threshold.

11. The method according to claim 10, wherein the comparing the sub-mesh symmetry ratio to the third symmetry threshold and the fourth symmetry threshold comprises determining the sub-mesh to be partially symmetric based on determining the sub-mesh symmetry ratio is less than the third symmetry threshold and greater than or equal to the fourth symmetry threshold.

12. The method according to claim 11, wherein the comparing the sub-mesh symmetry ratio to the third symmetry threshold and the fourth symmetry threshold comprises determining the sub-mesh to be fully symmetric based on determining the sub-mesh symmetry ratio is greater than or equal to the third symmetry threshold.

13. The method according to claim 12, wherein the comparing the sub-mesh symmetry ratio to the third symmetry threshold and the fourth symmetry threshold comprises determining the sub-mesh to be asymmetric based on determining the sub-mesh symmetry ratio is less than the fourth symmetry threshold.

14. The method according to claim 1, wherein the dividing the mesh into a plurality of sub-meshes based on the clustering process comprises:
divide the mesh into a first sub-mesh and a second sub-mesh;
determine a first symmetry plane of the first sub-mesh;
determine, using the first symmetry plane, a first symmetry error of the first sub-mesh;
determine a second symmetry plane of the second sub-mesh;
determine, using the second symmetry plane, a second symmetry error of the second sub-mesh;
compute an average symmetry error based on the first symmetry error and the second symmetry error;
split the first sub-mesh into separate sub-meshes based on a determination the first symmetry error is greater than the average symmetry error; and
split the second sub-mesh into separate sub-meshes based on a determination the second symmetry error is greater than the average symmetry error.

15. A method of encoding a mesh, the method comprising:
generating a bitstream comprising the mesh;
wherein the mesh is divided by a global symmetry plane into a first side and a second side;
wherein the mesh is determined to be, using the global symmetry plane, whether one of fully symmetric, partially symmetric, and asymmetric based on a statistical calculation performed on a plurality of vertices in the mesh;
wherein based on the determination that the mesh is partially symmetric:
each vertex from the plurality of vertices having a symmetry error larger than a first error threshold is determined;
a clustering process is performed on the plurality of vertices based on the determined symmetry error for each vertex such that each vertex having a symmetry error larger than the first symmetry error threshold is clustered together in one or more clusters;
the mesh is divided into a plurality of sub-meshes based on the clustering process;
each sub-mesh is determined to be one of fully symmetric, partially symmetric, and asymmetric; and
symmetry coding is performed on each sub-mesh from the plurality of sub-mesh that is determined to be fully symmetric.

16. The method according to claim 15, wherein determining whether the mesh is one of fully symmetric, partially symmetric, and asymmetric comprises:
determining a symmetry error for each vertex in the mesh;
determining a number of vertices having the symmetry error less than a second error threshold;
determining a symmetry ratio of the mesh by dividing the number of vertices having the symmetry error less than the second error threshold by a total number of vertices in the mesh; and
comparing the symmetry ratio to a first symmetry threshold and a second symmetry threshold that is less than the first symmetry threshold.

17. The method according to claim 16, wherein the comparing the symmetry ratio to the first symmetry threshold and the second symmetry threshold comprises determining the mesh to be partially symmetric based on determining the symmetry ratio is less than the first symmetry threshold and greater than or equal to the second symmetry threshold.

18. The method according to claim 17, wherein the comparing the symmetry ratio to the first symmetry threshold and the second symmetry threshold comprises determining the mesh to be fully symmetric based on determining the symmetry ratio is greater than or equal to the first symmetry threshold.

19. The method according to claim 4, wherein the comparing the symmetry ratio to the first symmetry threshold and the second symmetry threshold comprises determining the mesh to be asymmetric based on determining the symmetry ratio is less than the second symmetry threshold.

20. A method of decoding a mesh, the mesh comprising:
receiving a bitstream comprising the mesh;
wherein the mesh is divided by a global symmetry plane into a first side and a second side;
wherein the mesh is determined to be, using the global symmetry plane, whether one of fully symmetric, partially symmetric, and asymmetric based on a statistical calculation performed on a plurality of vertices in the mesh;
wherein based on the determination that the mesh is partially symmetric:
each vertex from the plurality of vertices having a symmetry error larger than a first error threshold is determined;
a clustering process is performed on the plurality of vertices based on the determined symmetry error for each vertex such that each vertex having a symmetry error larger than the first symmetry error threshold is clustered together in one or more clusters;
the mesh is divided into a plurality of sub-meshes based on the clustering process;
each sub-mesh is determined to be one of fully symmetric, partially symmetric, and asymmetric; and
symmetry coding is performed on each sub-mesh from the plurality of sub-mesh that is determined to be fully symmetric.
